(19) United States
(12) Patent Application Publication
(10) Pub. No.: US 2005/0259768 A1
(43) Pub. Date: Nov. 24, 2005

(54) Digital receiver and method for processing received signals

(75) Inventors: Chunhua Yang, Newbury (GB); Theng Tee Yeo, Singapore (SG); Masayuki Tomisawa, Singapore (SG)

Correspondence Address: OSTROLENK FABER GERB & SOFFEN, 1180 AVENUE OF THE AMERICAS, NEW YORK, NY, 100368403, US

(73) Assignee: Oki Techno Centre (Singapore) Pte Ltd

(21) Appl. No.: 11/130,318

(22) Filed: May 16, 2005

(30) Foreign Application Priority Data
May 21, 2004 (SG) 200403061-5

(51) Int. Cl. H04L 27/08

(52) U.S. Cl. 375/345

(57) ABSTRACT

A digital receiver for a burst-mode wireless communication system, such as a Bluetooth system comprises a radio frequency input stage for receiving an input signal and an analogue-to-digital converter for converting the input signal from an analogue signal to a digital signal. A switch is coupled to the analogue-to-digital converter and a first signal processor is coupled to the switch and is arranged to demodulate signals modulated according to a first modulation process, such as a GFSK modulation process. A second signal processor is also coupled to the switch and is arranged to demodulate signals modulated according to a second modulation process, such as π/4DQPSK modulation process or an 8DPSK modulation process. The switch is arranged to switch the digital signal between the first and second signal processors to recover signals from the first and/or the second modulation process. A method for processing received signals in a burst-mode wireless communication system is also disclosed.

### FIELD OF THE INVENTION

The present invention relates to a digital receiver, in particular to a digital receiver for a burst-mode wireless communication system, and to a method for processing received signals in a burst-mode wireless communication system.

### BACKGROUND OF THE INVENTION

To improve the transmission rate in burst-mode wireless communication systems, a multi-format modulation system may be adopted. For example, in a Bluetooth system, three different modulation options may be employed for medium rate applications. The packet format specification for medium rate Bluetooth systems is shown in FIG. 1 and requires two different modulation systems encompassed within a single packet. The access code and packet header are transmitted at 1 Mbps basic rate based on GFSK modulation [as required by the Specification of the Bluetooth System—Part A Radio Specification (Version 1.1, February 2001)]. Subsequent payload and synchronization sequences are then transmitted using either a π/4DQPSK or an 8DPSK modulated scheme. π/4DQPSK and 8DPSK are linear modulation schemes with similar linearity properties. A guard signal period may be inserted between the packet header and the synchronization sequence.

It is relatively easy to design a receiver which can simultaneously detect a π/4DQPSK modulated signal and an 8DPSK modulated signal. However, GFSK modulation is a non-linear modulation system and the receiver for use with such a system will differ significantly from a receiver designed to detect linear modulation. The reason for this is that a receiver designed to handle GFSK modulation must be capable of handling the nonlinearity introduced by the modulation process.

Bluetooth is a popular short-range communication standard that provides low-cost radio connections between various electronic devices. A Bluetooth receiver designed to handle medium rate signals is often required to be compatible with existing standards. This means that such a receiver should not only meet the requirements defined by the Specification of the Bluetooth System—Part A Radio Specification (Version 1.1, February 2001), but also the requirements defined by the Radio 1.0 Improvements: Medium Rate RF Specification Version 0.72. Furthermore, the interference requirements associated with Bluetooth receivers designed to handle medium rate signals are quite different from the original Bluetooth specification [as stated in the Specification of the Bluetooth System—Part A Radio Specification (Version1.1, February 2001)].

One way of achieving low-cost and compact size in receiver design is to integrate the components forming the receiver, as far as possible. Very high integration may be achieved by using a zero-IF receiver, that is, a receiver which does not have an intermediate frequency. However, zero-IF receivers suffer from poor performance, which limits their use. By contrast, a conventional IF (heterodyne) receiver may achieve a good performance, but such a receiver requires many off-chip components.

In view of the foregoing requirements, a need exists for a fully-integrated receiver that can handle multi-format modulations with the constraints of low power-consumption and which is compact in silicon size and low in cost.

### SUMMARY OF THE INVENTION

According to a first aspect of the invention there is provided a digital receiver for a burst-mode wireless communication system comprising:
a radio frequency (RF) input stage for receiving an input signal;
an analogue-to-digital converter for converting said input signal from an analogue signal to a digital signal;
a switch couplable to said analogue-to-digital converter;
a first signal processor couplable to said switch and arranged to demodulate one or more signals modulated according to a first modulation process; and
a second signal processor couplable to said switch and arranged to demodulate one or more signals modulated according to a second modulation process, said switch being arranged to switch said digital signal between said first and second signal processors to recover signals from said first modulation process and/or said second modulation process.

The digital receiver may further comprise a pair of mixers couplable to said analogue-to-digital converter to produce quadrature signals from said input signal. Said pair of mixers may be arranged to multiply said input signal by a two-phase locally generated signal, said two phases being in quadrature.

Said first modulation process may be a GFSK modulation process. Said second modulation process may be a π/4DQPSK modulation process. Said second modulation process may be an 8DPSK modulation process.

Said radio frequency (RF) input stage may comprise: a band-pass filter for restricting said input signal to a predetermined bandwith, said input signal having an operating frequency; a low noise amplifier couplable to said band-pass filter for amplifying said input signal; an oscillator couplable to a mixer, said mixer being couplable to said low noise amplifier, said oscillator and said mixer being arranged for reducing said operating frequency to a low intermediate frequency; a complex band-pass filter system having one or more variable gain amplifiers, said complex band-pass filter system being couplable to said mixer; and an automatic gain control circuit couplable to said complex band-pass filter system for controlling the gain of said one or more variable gain amplifiers to produce a predetermined output signal level.

Said first signal processor may comprise a differential demodulator for recovering data from said input signal. Said first signal processor may further comprise: a filter device couplable to said differential demodulator for removing selected frequency components; a decider unit couplable to said filter device; and a timing recovery unit couplable to said decider unit, said decider unit and said timing recovery unit being arranged to recover a symbol clock from said input signal.

Said first signal processor may further comprise a decimator coupled to said differential demodulator to reduce the frequency of the input signal and to reduce the rate at which said differential demodulator and said filter device operate.

Said first signal processor may further comprise an interpolator couplable between said filter device and said decider unit, said interpolator being arranged to increase the frequency of said input signal.

Said second signal processor may comprise: a timing recovery unit to extract a symbol clock from said input signal; a differential demodulator for demodulating said input signal, said differential demodulator having an output and an input, said input being couplable to said timing recovery unit; a phase-lock loop system for tracking and compensating for phase errors due to frequency offset and/or drift; said phase-lock loop system having an output and comprising a first mixer for mixing the output of the phase-lock loop system with the output of the differential demodulator, said first mixer having an output; a slicer couplable to the output of the first mixer for applying soft decision decoding to the output of said first mixer, said slicer having an input and an output, the input and output of the slicer being couplable to a second mixer to provide a control signal to the phase-lock loop system; and a demapper circuit for demapping the output of the slicer into bits to provide an output signal representative of the input signal.

Said second signal processor may further comprise a decimator having an output couplable to the input of said differential demodulator.

Said timing recovery unit may comprises: a first filter for filtering said input signal to estimate the timing error, said filter having an output, said output being arranged to drive an interpolator control logic unit, said interpolator control logic unit being arranged to control an interpolator operating on said input signal for producing a symbol clock for said differential demodulator.

Said first filter may comprise a first order adaptive planar filter. Said first filter may comprise an infinite impulse response filter.

According to a second aspect of the invention there is provided the digital receiver defined above for use in a standard rate and/or medium rate Bluetooth system.

According to a third aspect of the invention there is provided a method for processing received signals in a burst-mode wireless communication system comprising:
receiving an input signal in a radio frequency (RF) input stage;
converting said input signal from an analogue signal to a digital signal;
switching said digital signal between a first signal processor and a second signal processor to recover signals from a first modulation process and/or a second modulation process.

The step of switching said digital signal between the first signal processor and the second signal processor may comprise switching the signal to the first signal processor when said first modulation process is a GFSK modulation process.

The step of switching said digital signal between the first signal processor and the second signal processor may comprise switching the signal to the second signal processor when said second modulation process is a π/4 DQPSK modulation process.

The step of switching said digital signal between the first signal processor and the second signal processor may comprise switching the signal to the second signal processor when said second modulation process is an 8DPSK modulation process.

The step of receiving said input signal may comprise: filtering said input signal to restrict said input signal to a predetermined bandwith, said input signal having a frequency; amplifying said filtered input signal; reducing the frequency of the input signal to a low IF frequency by mixing the input signal with a signal from a local oscillator; and passing the low IF signal through a complex band-pass filter having an automatic gain control system to produce a predetermined output signal level.

The method may further comprise mixing the digital signal with phase and quadrature signals from a second oscillator to produce phase and quadrature variants of the digital signal.

The method may further comprise filtering the phase and quadrature variants of the digital signal using a number of square root raised cosine (SRRC) filters to remove selected frequency components and produce two baseband orthogonal components of said digital signal.

The method may further comprise decimating said input signal to said first signal processor to reduce the frequency of the input signal.

The method may further comprise demodulating said digital signal in said first signal processor to recover data from said input signal when modulated according to said first modulation process.

The method may further comprise the following steps in the first signal processor: filtering selected frequency components from said input signal after demodulating said input signal; and recovering a symbol clock from said input signal after filtering said input signal.

The method may further comprise reducing the frequency of the input signal to reduce the rate at which the steps of demodulating and filtering said input signal operate.

The method may further comprise interpolating sample pulses into said input signal in said first signal processor to increase the frequency of said input signal before recovering said symbol clock.

The method may further comprise the following steps in the second signal processor: extracting a symbol clock from said input signal; demodulating said input signal; and tracking and compensating for phase errors due to frequency offset and/or drift using a phase-lock loop system;

The method may further comprise using a symbol clock obtained in said first signal processor to synchronise the symbol clock obtained in the second signal processor to drive the demodulation of said input signal.

The method may further comprise decimating said input signal before extracting said symbol clock from said input signal.

The method may further comprise, before extracting said symbol clock, filtering said input signal to estimate a timing error, and using said timing error to drive an interpolator control logic unit to control an interpolator operating on said input signal for producing the symbol clock for said differential demodulator.

The step of filtering may comprise filtering said signal using a first order adaptive planar filter. The step of filtering may comprise filtering said signal using an infinite impulse response filter.

According to a fourth aspect of the invention there is provided a method for processing received signals in a standard rate and/or medium rate Bluetooth system comprising the method steps defined above.

The systems and methods according to the present invention may be particularly useful in the production of devices for use, for example, as a single-chip digital receiver for a burst mode communication system. The digital receiver according to an embodiment of the present invention is suitable for implementation as an ASIC and is insensitive to frequency offset. The digital receiver and method for for processing received signals in a burst-mode wireless communication system according to embodiments of the present invention can detect GFSK modulated signals and DPSK modulated signals. Furthermore, the low-IF receiver embodying the invention has a multi-path topology which is suitable for a highly integrated, reduced cost and reduced size design. The low-IF receiver uses an intermediate frequency (IF) of a few hundred kilohertz and is insensitive to parasitic baseband signals, such as DC offset and self-mixing products. Furthermore, the receiver according to an embodiment of the invention has a high performance and is highly integratable.

### BRIEF DESCRIPTION OF THE DRAWINGS

Embodiments of the invention will now be described, by way of example, and with reference to the accompanying drawings, in which:

FIG. 1 is a schematic diagram showing the structure of a medium rate data packet in a conventional medium rate Bluetooth system;

FIG. 2 is a schematic diagram of a digital receiver according to an embodiment of the invention;

FIG. 3 is a schematic diagram of the analogue input of the digital receiver of FIG. 2;

FIG. 4 is a schematic diagram of a signal processor in the digital receiver of FIG. 2 arranged to detect GFSK modulated signals;

FIG. 5 is a schematic diagram of an alternative signal processor for use in the digital receiver of FIG. 2 arranged to detect GFSK modulated signals;

FIG. 6 is a schematic diagram of a further signal processor for use in the digital receiver of FIG. 2 arranged to detect DPSK modulated signals;

FIG. 7 is a schematic diagram of a timing recovery system for use in the digital receiver of FIG. 2 arranged to receive DPSK modulated signals; and

FIG. 8 is a schematic diagram of an alternative further signal processor for use in the digital receiver of FIG. 2 arranged to detect DPSK modulated signals.

### DETAILED DESCRIPTION OF PREFERRED EMBODIMENTS

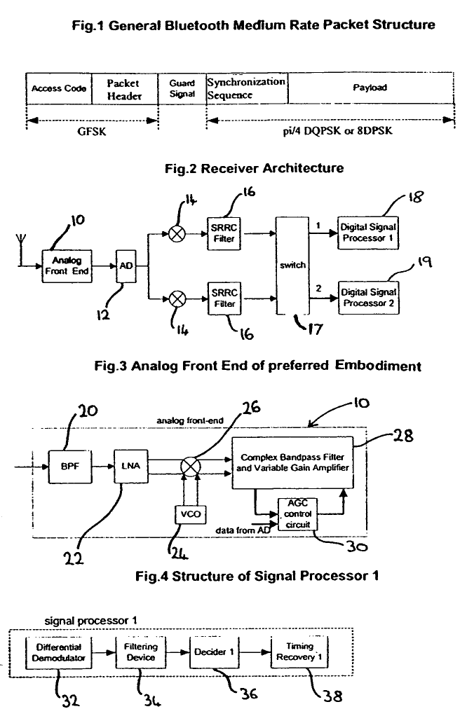

As mentioned above, FIG. 1 shows the packet format specification for medium rate Bluetooth systems. The specification requires two different modulation systems encompassed within a single packet. The access code and packet header are transmitted at 1 Mbps basic rate based on GFSK modulation [as required by the Specification of the Bluetooth System—Part A Radio Specification (Version 1.1, February 2001)]. Subsequent payload and synchronization sequences are then transmitted using either π/4DQPSK or an 8DPSK modulation scheme. π/4DQPSK and 8DPSK are linear modulation schemes with similar linearity properties. A guard signal period may be inserted between the packet header and the synchronization sequence.

FIGS. 2 to 8 show various aspects of a receiver according to a number of preferred embodiments of the invention as used to receive and process the packet structure of FIG. 1.

FIG. 2 shows a low-IF (intermediate frequency) digital receiver for a burst-mode wireless communication system, according to a preferred embodiment of the invention. The receiver comprises an analogue front-end section 10 arranged to convert an RF signal received from an antenna into a low intermediate frequency (IF) signal. An analogue-to-digital converter 12 is arranged to provide analogue-to-digital conversion of the output from the analogue front-end section 10 and a pair of mixers 14 is coupled to the output of the analogue-to-digital converter 12. One of the mixers in the pair 14 is arranged to mix the analogue-to-digital converted signal with sine signals and the other mixer is arranged to mix the analogue-to-digital converted signal with cosine signals in order to obtain two orthogonal components of the low IF signal, namely, I′ₙ and Q′ₙ.

A pair of matched square root raised cosine filters (SRRC filters) 16 is coupled to the pair of mixers 14 and is arranged to filter high frequency contents of the two orthogonal components I′ₙ and Q′ₙ to obtain two baseband orthogonal components, namely, Iₙ and Qₙ.

A switch 17 is arranged to switch the output signals, Iₙ and Qₙ, of the matched square root raised cosine filters (SRRC filters) 16, to a first path, ‘path 1’, or a second path, ‘path 2’. A first digital signal processor 18 is arranged to detect a GFSK modulated signal and a second digital signal processor 19 is arranged to detect a π/4DQPSK or an 8DPSK signal.

To receive a Bluetooth basic rate signal, the switch 17 will be connected to the first signal processor 18 along path 1, during reception of the whole packet.

To receive a Bluetooth medium rate signal, the switch 17 is connected to the first signal processor 18 along path 1 during reception of the access code and the packet header and the switch 17 is connected to the second signal processor 19 along path 2 for the remainder of the packet. The first and second signal processors 18 and 19 should ideally share as many common processing modules as possible.

Hereinafter, with reference to FIGS. 3 to 6, the operations of the analogue front-end section 10 shown in FIG. 2, and the first and second signal processors 18 and 19 are explained.

FIG. 3 schematically illustrates the structure of the analogue front-end section 10 of the digital receiver shown in FIG. 2. The analogue front-end section 10 includes a band-pass filter 20 arranged to filter the signal received from the antenna to suppress unwanted spectrum of the received signal. The output of the band-pass filter 20 is coupled to a low noise amplifier 22 which covers the whole bandwidth of the receiver and is arranged to provide low noise amplification of the band-pass filtered signal from the band-pass filter 20.

A voltage controlled oscillator 24 is arranged to generate a local oscillating signal and is connected to a mixer 26. The mixer 26 is arranged to mix the amplified signal from low noise amplifier 22 with the local oscillating signals from voltage controlled oscillator 24, to down-convert the frequency of the received signal into a low intermediate frequency f_{IF}, for example, f_{IF}=1 MHz.

The output of the mixer 26 is coupled to a complex band-pass filter/variable gain amplifier unit 28 which comprises a complex band-pass filter and one or more variable gain amplifiers. The complex band-pass filter is centred at f_{IF} and is arranged to band-pass filter the signal from the mixer 26 in order to suppress any signals which fall outside of the bandwidth. An automatic gain control circuit 30 is arranged to provide a predetermined signal level at the output of the complex band-pass filter and to control the gain of the variable gain amplifiers in the complex band-pass filter/variable gain amplifier unit 28 to achieve this level.

A first preferred structure of the first signal processor 18 is illustrated in FIG. 4. The first signal processor 18 operates at a frequency fₛ and it comprises a differential demodulator 32 for receiving the signals switched along path 1 by the switch 18 shown in FIG. 2. The output of the differential demodulator 32 is coupled to a filtering device 34 and the output of the filtering device 34 is coupled to the input of a first decider unit 36. The output of the first decider unit 36 is coupled to a first timing recovery unit 38.

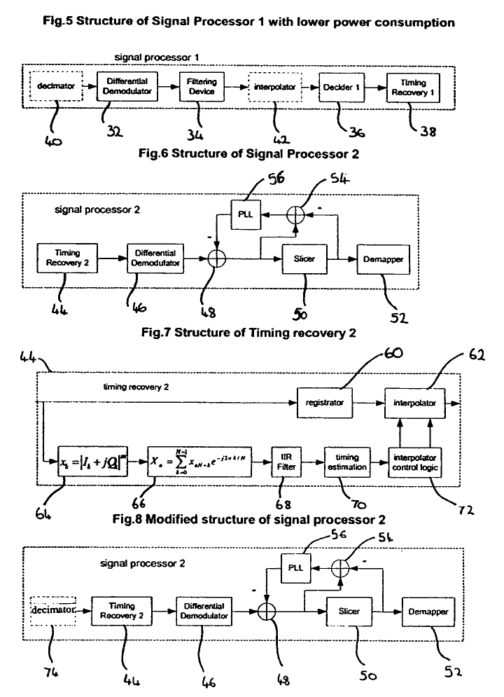

Power consumption of the first signal processor 18 is dominated by the differential demodulator 32 and the filtering device 34. To reduce power consumption, an alternative structure for the first signal processor 18 is proposed and is illustrated in FIG. 5.

The alternative first signal processor comprises an additional decimator 40 at the input and the output of the decimator is coupled to the input of the differential demodulator 32. Additionally, an interpolator 42 is coupled between the filtering device 34 and the first decider unit 36.

A first preferred structure of the second signal processor 19 is illustrated in FIG. 6. A timing recovery unit 44 is arranged to receive the signals switched along path 2 by the switch 17 shown in FIG. 2. The output of the timing recovery unit 44 is coupled to a differential demodulator 46 and the output of the differential demodulator 46 is coupled to a first mixer 48. The output of the first mixer 48 is fed to the input of a slicer 50. The output of the slicer 50 is fed to a demapper 52. The output from the demapper 52 forms the demodulated payload signal for path 2. The output from the first mixer 48 and the output from the slicer 50 are mixed in a second mixer 54 and the mixed signal controls a phaselock loop (PLL) 56, the output of which is mixed in the first mixer 48 with the output from the differential demodulator 46.

The structure of the timing recovery unit 44 of the second signal processor 19 is shown in FIG. 7. The signals switched along path 2 by the switch 17 are received by a registrator 60, the output of which is fed to an interpolator 62. The output of the interpolator 62 is fed to the differential demodulator 46 shown in FIG. 6.

As well as being fed to the registrator 60, the signals switched along path 2 by the switch 17 are also fed to a first processing stage 64. The output from the first processing stage 64 is fed to a second processing stage 66, the output of which is fed to an infinite impulse response (IIR) filter 68. The output of the infinite impulse response (IIR) filter 68 is connected to the input of a timing estimation unit 70, the output of which is connected to an interpolator control logic unit 72 which controls the operation of the interpolator 62.

To reduce power consumption, an alternative structure for the second signal processor 19 is proposed and is illustrated in FIG. 8. The alternative second signal processor differs from that shown in FIG. 6 in that a decimator 74 is placed at the input of the timing recovery unit 44. Thus, data fed to the timing recovery unit 44 may be decimated to a lower operating frequency and the remaining timing estimation algorithms may thereby operate at a lower frequency to estimate the timing error, thereby further reducing the power consumption.

The analogue front-end system 10 translates the high frequency signal directly received from the antenna to a signal with low intermediate frequency whilst maintaining the signal strength at a constant level prior to being fed to the analogue-to-digital converter 12. The analogue-to-digital converter 12 is operated at a sampling rate of fₛ, for example, around 8 MHz.

The low intermediate frequency (IF) signal from the analogue-to-digital converter 12 is further down-converted to a baseband signal by the pair of mixers 14 coupled with the square root raised cosine filters (SRRC) 16 whose rolling factors may be set at, for example, 0.4, and whose 3 dB bandwidths may be, for example, 1 MHz. Each of the mixers 14 in the pair mixes the digital signals from the analogue-to-digital converter 12 with sine (sin 2πf_{IF}t) and cosine (cos 2πf_{IF}t), respectively to obtain the two orthogonal components, I′ₙ and Q′ₙ.

After removal of high frequency terms of the two orthogonal components by the pair of square root raised cosine filters (SRRC) 16, the two orthogonal baseband components (that is, the in-phase and quadrature base-band components Iₙ and Qₙ for GFSK modulated signal) yield:
Iₙ=−A sin [2πΔ_{f}nTₛ+Φ(nTₛ)+θ]+wₙ₁
Qₙ=A cos [2πΔ_{f}nTₛ+Φ(nTₛ)+θ]+wₙ₂ (1)
where A is the amplitude of the received signal, Δ_{f} is the frequency difference between the transmitter and receiver, Tₛ is the sample duration, Φ(nTₛ) is the phase of GFSK modulated signal, θ is the phase offset introduced by the voltage controlled oscillator 24 in the receiver and wₙ₁ and wₙ₂ are the nth samples of white Gaussian noise.

The first and second signal processors 18 and 19 perform demodulation, frequency offset compensation, timing synchronization and decoding of the outputs of the square root raised cosine filters (SRRC) 16 to produce the packet signals.

The operation of the first signal processor 18 is as follows. To recover a GFSK signal, the output signals, Iₙ and Qₙ, of the matched square root raised cosine filters (SRRC filters) 16 are switched to the first signal processor 18 by the switch 17. The differential demodulator 32 in the first signal processor 18 calculates the phase difference in the modulated signal over one sampling period or symbol duration. The differential demodulator 32 applies an arctangent function to the signals to extract the signal phase and a difference function in order to determine the phase change over one sample or symbol interval. After application of the difference function, a modulo-2π function is applied to perform the following operation:
if ΔΦₖ<−π, ΔΦₖ=ΔΦₖ+2π
if ΔΦₖ>π, ΔΦₖ=ΔΦₖ−2π (2)

The filtering device 34 in the first signal processor 18, which follows the differential demodulator 32, estimates and removes frequency offset and drift. The details of a suitable filtering device for use as the filtering device 34 in embodiments of the present invention are referred to in Singapore patent application no. 200207436-7, the details of which are incorporated herein by reference.

After removing the effects of frequency drift, hard decision decoding is applied by the decider unit 36. The timing recovery unit 38 then generates a symbol clock by detecting the zero-crossing position of the hard decision signal waveform. The timing recovery unit 38 is very simple and preferably has a high tracking speed. The transmitted digital information is recovered from the output of the timing recovery unit 38.

The frequency offset cancellation and symbol clock recovery circuitry are implemented in a feedforward manner. The complexity is low because there is no feedback circuit required to compensate for frequency and timing errors. Furthermore, these components may be conveniently implemented in a digital form.

As mentioned above, power consumption of the first signal processor 18 is dominated by the differential demodulator 32 and the filtering device 34. To reduce power consumption, the alternative structure for the first signal processor 18 illustrated in FIG. 5 is proposed. The output signal from the square root raised cosine filter (SRRC filter) 16 in signal path 1 is decimated to a lower operating frequency using the decimator 40, which precedes the differential demodulator 32, so that demodulation and filtering takes place at a lower frequency and thus requires less power. Subsequently, to maintain good performance of the timing recovery, the data is sampled at higher rate in the interpolator 42 and then passed to the decider 36 and timing recovery units 38, as described above in connection with the first signal processor illustrated in FIG. 4.

To recover the data in the payload of a medium rate packet in a Bluetooth system, the switch 17 is operated at the end of header reception shown in FIG. 1, to connect the signal to the second signal processor 19 to recover either the π/4DQPSK or the 8DPSK modulated payload. The automatic gain control unit 30 in the front end section 10 is inhibited and the gain of the variable gain amplifiers in the complex bandpass filter/variable gain amplifier unit 28 is frozen. The estimated frequency offset from filtering device 34 of the first signal processor 18 is used to initialize the phaselock loop (PLL) 56 in the second signal processor 19.

The symbol timing at the start of the synchronization sequence in the medium rate data packet must be within ¼ μs of the symbol timing of the last GFSK symbol of the packet header. During reception of synchronization sequence, the symbol clock obtained from the timing recovery unit 38 in the first signal processor 18 is directly used as a symbol clock for the synchronization sequence.

The timing recovery unit 44 of the second signal processor 19, which is shown in FIG. 7, operates as follows. The first stage 64 comprises processing according to the application of a general type of non-linearity xₖ=|Iₖ+jQₖ|^{m} (m=1, 2, 4), to estimate the timing error. In this case, k=0, 1, . . . , N-1 where N is the oversampling factor, n is the timing instant measured in symbol timing duration, and xₖ is an interval variable defined to be xₖ=|Iₖ+jQₖ|^{m} which is calculated at the sample rate.

The second stage 66 comprises the calculation of the Fast Fourier Transform (FFT) Xₙ of xₖ in the nth symbol duration. Xₙ is obtained at symbol rate and forms the input signal to the infinite impulse response (IIR) filter 68. The infinite impulse response (IIR) filter 68 is used to average Xₙ operating at symbol rate and is preferably a first-order adaptive planar filter which is arranged to perform the following calculation:
yₙ=(1−αₙ)yₙ₋₁+αₙXₙ (2)
where αₙ is the coefficient of the IIR filter 68.

The output yₙ of the IIR filter 68 is used by the timing estimation unit 70 to estimate the timing error.

During the reception of the synchronization sequence, the coefficient αₙ of the IIR filter 68 is fixed to a large initial value which allows a faster convergence. At the end of the synchronization sequence, the coefficient αₙ gradually decreases to a smaller value as a function of time which assists in the suppression of noise and further improves the performance of the timing estimation unit 70. The timing estimation unit 70 estimates the relative timing shift \hat{ε}ₙ normalized to the symbol rate using the equation:

$${\hat{ɛ}}_{n} = - \frac{1}{2 π} arg ( {y}_{n} ) \qquad ( 3 )$$

The interpolator control logic unit 72 determines the control signals for the interpolator 62 normalized to the sampling rate. The optimum sample at symbol rate is recovered by the interpolator 62. The timing error \hat{ε}ₙ changes very slowly and thus the timing estimation unit 70 and the interpolator control logic unit 72 can be updated at a rate which is lower than symbol rate.

In an alternative embodiment, the interpolator 42 of the first signal processor 18, as shown in FIG. 5 may be reused by the second signal processor as the interpolator 62.

To reduce power consumption, the data input to the timing recovery unit 44 of the second signal processor 19 may be decimated to a lower operating frequency using the decimator 74 shown in FIG. 8. Alternative timing estimation algorithms operating at lower frequencies may be used to estimate the timing error and reduce the power consumption further. After decimating the data to symbol rate, differential demodulation is performed. The differential demodulator 32 of the first signal processor 18 differs from the differential demodulator 46 of the second signal processor 19 in that the differential demodulator 32 of the first signal processor 18 operates at the sampling rate whereas the differential demodulator 46 of the second signal processor operates at the symbol rate.

The decision directed phaselock loop (PLL) 56 is used to track and correct the phase error caused by frequency offset and drift. The estimated frequency offset obtained from the first signal processor 18 is used to initialize the phaselock loop (PLL) 56.

It is not necessary to adjust the sampling clock of the analogue-to-digital converter 12 to compensate for timing and frequency errors, so the operation of the phaselock loop (PLL) 56 involves only simple logic and arithmetic operations such as addition, subtraction and shifting. The complexity of the phaselock loop (PLL) 56 is thereby greatly reduced.

The slicer 50 in the second signal processor 19 applies soft-decision decoding to the signals therethrough and the demapper 52 maps the soft-decision decoded signals to bits to provide the output.

Simulation results suggest that the aforementioned digital receiver according to embodiments of the invention meets not only the specifications defined by Bluetooth Basic rate as defined in the Specification of the Bluetooth System—Part A Radio Specification (Version 1.1, February 2001), but also the specifications defined by Bluetooth medium rate as defined in Radio 1.0 Improvements: Medium Rate RF Specification Version 0.7.

In conclusion, the systems and methods according to the present invention may be particularly useful in the production of devices for use, for example, as a single-chip digital receiver for a burst mode communication system. The digital receiver of the present invention is suitable for implementation as an ASIC and is insensitive to frequency offset. The digital receiver and method for processing received signals in a burst-mode wireless communication system embodying the present invention can detect GFSK modulated signals and DPSK modulated signals. Furthermore, the low-IF receiver has a multi-path topology which is suitable for a highly integrated, reduced cost and reduced size design. The low-IF receiver uses an intermediate frequency (IF) of a few hundred kilohertz and is insensitive to parasitic baseband signals, such as DC offset and self-mixing products. The receiver according to an embodiment of the invention has a high performance and is highly integratable.

Various modifications to the embodiments of the present invention described above may be made. For example, other components and method steps can be added or substituted for those above. Thus, although the invention has been described above using particular embodiments, many variations are possible within the scope of the claims, as will be clear to the skilled reader, without departing from the spirit and scope of the invention.

1. A digital receiver for a burst-mode wireless communication system comprising:
a radio frequency (RF) input stage for receiving an input signal;
an analogue-to-digital converter for converting said input signal from an analogue signal to a digital signal;
a switch couplable to said analogue-to-digital converter;
a first signal processor couplable to said switch and arranged to demodulate one or more signals modulated according to a first modulation process; and
a second signal processor couplable to said switch and arranged to demodulate one or more signals modulated according to a second modulation process, said switch being arranged to switch said digital signal between said first and second signal processors to recover signals from said first modulation process and/or said second modulation process.

2. A digital receiver according to claim 1, further comprising a pair of mixers couplable to said analogue-to-digital converter to produce quadrature signals from said input signal.

3. A digital receiver according to claim 2, wherein said pair of mixers are arranged to multiply said input signal by a two-phase locally generated signal, said two phases being in quadrature.

4. A digital receiver according to claim 1, wherein said radio frequency (RF) input stage comprises:
a band-pass filter for restricting said input signal to a predetermined bandwith, said input signal having an operating frequency;
a low noise amplifier couplable to said band-pass filter for amplifying said input signal;
an oscillator couplable to a mixer, said mixer being couplable to said low noise amplifier, said oscillator and said mixer being arranged for reducing said operating frequency to a low intermediate frequency;
a complex band-pass filter system having one or more variable gain amplifiers, said complex band-pass filter system being couplable to said mixer; and
an automatic gain control circuit couplable to said complex band-pass filter system for controlling the gain of said one or more variable gain amplifiers to produce a predetermined output signal level.

5. A digital receiver according to claim 1, wherein said first signal processor comprises a differential demodulator for recovering data from said input signal.

6. A digital receiver according to claim 5, wherein said first signal processor further comprises:
a filter device couplable to said differential demodulator for removing selected frequency components;
a decider unit couplable to said filter device; and
a timing recovery unit couplable to said decider unit, said decider unit and said timing recovery unit being arranged to recover a symbol clock from said input signal.

7. A digital receiver according to claim 6, wherein said first signal processor further comprises a decimator coupled to said differential demodulator to reduce the frequency of the input signal and to reduce the rate at which said differential demodulator and said filter device operate.

8. A digital receiver according to claim 7, wherein said first signal processor further comprises an interpolator couplable between said filter device and said decider unit, said interpolator being arranged to increase the frequency of said input signal.

9. A digital receiver according to claim 1 wherein said second signal processor comprises:
a timing recovery unit to extract a symbol clock from said input signal;
a differential demodulator for demodulating said input signal, said differential demodulator having an output and an input, said input being couplable to said timing recovery unit;
a phase-lock loop system for tracking and compensating for phase errors due to frequency offset and/or drift; said phase-lock loop system having an output and comprising a first mixer for mixing the output of the phase-lock loop system with the output of the differential demodulator, said first mixer having an output;
a slicer couplable to the output of the first mixer for applying soft decision decoding to the output of said first mixer, said slicer having an input and an output, the input and output of the slicer being couplable to a second mixer to provide a control signal to the phase-lock loop system; and
a demapper circuit for demapping the output of the slicer into bits to provide an output signal representative of the input signal.

10. A digital receiver according to claim 9, wherein said timing recovery unit comprises:
a first filter for filtering said input signal to estimate the timing error, said filter having an output, said output being arranged to drive an interpolator control logic unit, said interpolator control logic unit being arranged to control an interpolator operating on said input signal for producing a symbol clock for said differential demodulator.

11. A digital receiver according to claim 1 for use in a standard rate and/or medium rate Bluetooth system.

12. A method for processing received signals in a burst-mode wireless communication system comprising:
receiving an input signal in a radio frequency (RF) input stage;
converting said input signal from an analogue signal to a digital signal;
switching said digital signal between a first signal processor and a second signal processor to recover signals from a first modulation process and/or a second modulation process.

13. The method of claim 12, wherein the step of receiving said input signal comprises:
filtering said input signal to restrict said input signal to a predetermined bandwith, said input signal having a frequency;
amplifying said filtered input signal;
reducing the frequency of the input signal to a low IF frequency by mixing the input signal with a signal from a local oscillator; and
passing the low IF signal through a complex band-pass filter having an automatic gain control system to produce a predetermined output signal level.

14. The method of claim 12, further comprising mixing the digital signal with phase and quadrature signals from a second oscillator to produce phase and quadrature variants of the digital signal.

15. The method of claim 14, further comprising filtering the phase and quadrature variants of the digital signal using a number of square root raised cosine (SRRC) filters to remove selected frequency components and produce two baseband orthogonal components of said digital signal.

16. The method of claim 12, further comprising decimating said input signal to said first signal processor to reduce the frequency of the input signal.

17. The method of claim 12, further comprising demodulating said digital signal in said first signal processor to recover data from said input signal when modulated according to said first modulation process.

18. The method of claim 17, further comprising the following steps in the first signal processor:
filtering selected frequency components from said input signal after demodulating said input signal; and
recovering a symbol clock from said input signal after filtering said input signal.

19. The method of claim 18, further comprising reducing the frequency of the input signal to reduce the rate at which the steps of demodulating and filtering said input signal operate.

20. The method of claim 18, further comprising interpolating sample pulses into said input signal in said first signal processor to increase the frequency of said input signal before recovering said symbol clock.

21. The method of claim 12, further comprising the following steps in the second signal processor:
extracting a symbol clock from said input signal;
demodulating said input signal; and
tracking and compensating for phase errors due to frequency offset and/or drift using a phase-lock loop system;

22. The method of claim 21 further comprising using a symbol clock obtained in said first signal processor to synchronise the symbol clock obtained in the second signal processor to drive the demodulation of said input signal.

23. The method of claim 21, further comprising decimating said input signal before extracting said symbol clock from said input signal.

24. The method of claim 21, further comprising, before extracting said symbol clock, filtering said input signal to estimate a timing error, and using said timing error to drive an interpolator control logic unit to control an interpolator operating on said input signal for producing the symbol clock for said differential demodulator.

25. A method for processing received signals in a standard rate and/or medium rate Bluetooth system comprising the method steps of claim 12.
